(19) United States
(12) Patent Application Publication
(10) Pub. No.: US 2024/0086760 A1
(43) Pub. Date: Mar. 14, 2024

(54) SMART COLLABORATIVE MACHINE UNLEARNING

(71) Applicant: Accenture Global Solutions Limited, Dublin (IE)

(72) Inventors: Yann Fraboni, Nice (FR); Laura Wendy Hélène Sylvie Angèle Degioanni, Roquefort-les-Pins (FR); Richard Vidal, Antibes (FR); Laetitia Kameni, Juan-les-pins (FR)

(21) Appl. No.: 17/942,340

(22) Filed: Sep. 12, 2022

(51) Int. Cl. G06N 20/00

(52) U.S. Cl. CPC G06N 20/00

(57) ABSTRACT

Methods, systems and apparatus, including computer programs encoded on computer storage medium, for machine unlearning. In one aspect a method includes receiving a request to remove a client dataset from a machine learning model, the model being associated with noise sensitivities determined during training of the model on respective client datasets including the client; and in response to receiving the request: identifying, from stored noise sensitivities of the client, a most recent training iteration that produced a noise sensitivity that is below a predetermined threshold that is based on a noise standard deviation and predefined target privacy parameters; updating parameters of the model, comprising adding noise to model parameters for the most recent training iteration; and performing subsequent iterations of training of the model, wherein the model is initialized with the updated parameters and the subsequent iterations train the model on datasets excluding the dataset owned by the client.

### TECHNICAL FIELD

This specification generally relates to methods, systems, and devices for machine unlearning.

### BACKGROUND

Machine learning models extract features from training data to answer questions about new data. To forget a subset of training data completely, the models need to revert the effects of the subset of training data on the extracted features and models. This process is referred to as machine unlearning.

A naïve approach to machine unlearning is to retrain the features from scratch after removing the subset of data that is to be forgotten. By starting from a new initial model that is free from any data sample information, this unlearning method completely unlearns the data that is to be forgotten. However, this approach can be slow (especially when the set of training data is large) since training and unlearning take the same amount of time.

Another unlearning approach is to apply a transformation to the trained machine learning model such that the resulting model is identical to the one that would be trained without the subset of data that is to be forgotten. These transformations are referred to as scrubbing functions. The main drawback behind unlearning through model scrubbing is that application of a scrubbing function requires computation of a Hessian which, for large networks, can take a long time or even be intractable. Sometimes a scrubbing function is coupled with Gaussian noise to balance the Hessian approximation, however this typically yields insufficient forgetting performances.

Another unlearning approach includes adding noise to the trained machine learning model and retraining the machine learning model such that information from the subset of data that is to be forgotten cannot be retrieved. The noise is agnostic to specificities of the training data sets and information included in the machine learning model. This unlearning approach can be seen as adding differential privacy to the trained machine learning model before retraining is performed using training data that excludes the subset of data that is to be forgotten. This approach is suboptimal for several reasons. For example, the noise is not training data set specific and is therefore designed for the training data set that contributed the most specific information in the machine learning model. In addition, the noise is added at the end of the training. As such, a lot of specific information from the different training data sets is included in the machine learning model, which leads to a noise amplitude that is too big to leave information from the kept training datasets in the noised model. Therefore, retraining is almost identical to training from scratch.

### SUMMARY

This specification describes systems and methods for smart collaborative machine unlearning.

In general, one innovative aspect of the subject matter described in this specification may be embodied in methods that include receiving a request to remove a dataset owned by a client from a machine learning model, the machine learning model being associated with a set of noise sensitivities determined during training of the machine learning model on multiple datasets owned by respective clients including the client; and in response to receiving the request: identifying, from stored noise sensitivities of the client, a most recent training iteration that produced a noise sensitivity that is below a predetermined threshold, wherein the predetermined threshold is based on a noise standard deviation and predefined target privacy parameters; updating parameters of the machine learning model, comprising adding noise to machine learning model parameters for the most recent training iteration; and performing one or more subsequent iterations of training of the machine learning model, wherein the machine learning model is initialized with the updated parameters and the subsequent iterations train the machine learning model on multiple datasets excluding the dataset owned by the client.

Other implementations of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination thereof installed on the system that in operation causes or cause the system to perform the actions. One or more computer programs can be configured to perform particular operations or actions by virtue of including instructions that, when executed by data processing apparatus (e.g., one or more computers or computer processors), cause the apparatus to perform the actions.

The foregoing and other implementations can each optionally include one or more of the following features, alone or in combination. In some implementations each noise sensitivity bounds a difference between the machine learning model trained on the multiple datasets and the machine learning model trained on multiple datasets excluding the dataset owned by the client.

In some implementations the noise sensitivities track respective evolutions of an amount of client information included in the machine learning model during training.

In some implementations the noise sensitivity of the client is based on a difference between i) an aggregation of machine learning model parameters over the multiple datasets and ii) an aggregation of machine learning model parameters over the multiple datasets excluding the dataset owned by the client.

In some implementations the noise sensitivity of the client comprises a sum, over all preceding training iterations, of a Euclidean norm of the differences.

In some implementations the noise sensitivity of the client comprises a weighted sum, over all preceding training iterations, of a Euclidean norm of the differences, wherein the weights are based on regularization and convexity parameters of loss functions used by the clients.

In some implementations the noise standard deviation is common to each client.

In some implementations the predetermined threshold is given by ϵσ/c where ϵ represents a first predefined target privacy parameter, σ represents the noise standard deviation, and c=2 ln [symbol] (1.25/δ) [symbol] where δ represents a second predefined target privacy parameter.

In some implementations adding noise to machine learning model parameters comprises adding noise sampled from a normal distribution with zero mean.

In some implementations the method further comprises receiving a series of requests, each request requesting removal of one or more datasets owned by a respective set of clients from the machine learning model.

In some implementations the noise sensitivities determined during training of the machine learning model comprise a maximum noise sensitivity from a set of noise sensitivities computed for the set of clients.

In some implementations each noise sensitivity in the set of noise sensitivities comprises a difference between i) an aggregation of machine learning model parameters over a federated dataset of remaining clients after forgetting a client in the set of clients and ii) an aggregation of machine learning model parameters over the federated dataset of remaining clients after forgetting clients in a same request excluding a dataset owned by the client in the set of clients.

In some implementations the most recent training iteration that produced a noise sensitivity that is below a predetermined threshold is dependent on an index that represents a first training iteration for which noise sensitivities of the set of clients is above the predetermined threshold.

In some implementations the method further comprises, in response to receiving the request, removing the client from a list of currently available clients.

In some implementations the request to remove the dataset comprises a request to remove a dataset owned by one or more of: an attacker, a client that induces bias in the machine learning model, or a client that does not respect general data protection regulations.

In some implementations the number of subsequent iterations of training is less than a number of previous iterations performed during previous training of the machine learning model.

In some implementations the method further comprises using the trained machine learning model for inference.

In some implementations training the machine learning model on the multiple datasets comprises: initializing the machine learning model on initial machine learning model parameters; for each of multiple iterations: providing the clients with the initial machine learning model parameters or machine learning model parameters for a previous iteration, wherein each client uses a respective dataset to update the initial machine learning model parameters or machine learning model parameters for the previous iteration; receiving, from each of the clients, machine learning model parameters for the iteration; aggregating the received machine learning model parameters for the iteration; and providing the aggregated machine learning model parameters for the iteration as input for a subsequent iteration.

Some implementations of the subject matter described herein may realize, in certain instances, one or more of the following advantages.

A system implementing the presently described techniques can perform machine unlearning with reduced retraining times, e.g., compared to conventional methods such as retraining from scratch or traditional noising techniques. In particular, the presently described noise sensitivity metric enables the system to informatively and automatically select a best global model to perform retraining on. As a result, anonymity criterion is satisfied and the new model is obtained with a minimum amount of retraining.

In addition, a system implementing the presently described techniques can achieve improved operational efficiency. For example, if a client requests that their dataset be removed from the machine learning model, the system need not be put on hold during retraining. In case of real-time predictions, whether a client leaves or not, the system will operate as usual. This results in a significant reduction in system downtime. As another example, because the presently described noise sensitivity metric enables the system to select a best global model to perform retraining on, retraining is more targeted and redundant training steps are not repeated. Accordingly, required bandwidth is reduced and system communication costs are optimized and minimized.

The details of one or more implementations of the subject matter described in this specification are set forth in the accompanying drawings and the description below. Other potential features, aspects, and advantages of the subject matter will become apparent from the description, the drawings, and the claims.

### DESCRIPTION OF DRAWINGS

FIG. 1 is a block diagram of an example process for smart collaborative learning of a machine learning model.

FIG. 2 is a block diagram of an example process for smart collaborative unlearning of a machine learning model.

FIG. 3 is a block diagram of an example smart collaborative unlearning system.

FIG. 4 is a flowchart of an example process for smart collaborative learning of a machine learning model.

FIG. 5 is a flowchart of an example process for smart collaborative unlearning of a machine learning model.

FIGS. 6A and 6B show graphs that compare multiple unlearning approaches including retraining from scratch, traditional noising, and the presently described smart collaborative learning/unlearning approach.

FIG. 7 is a schematic diagram of an exemplary computer system.

Like reference symbols in the various drawings indicate like elements.

### DETAILED DESCRIPTION

This specification describes systems and methods for smart collaborative machine unlearning. Smart collaborative machine unlearning is a faster unlearning method that optimizes traditional unlearning to provide significantly reduced retraining times. During learning, a client-specific metric that tracks the evolution of each client amount of information included in the global machine learning model at every aggregation is computed. Based on this metric, a best global model for each client on which to perform retraining on can be informatively and automatically selected. As a result, the anonymity criterion is satisfied, and the new model is obtained with a minimum amount of retraining.

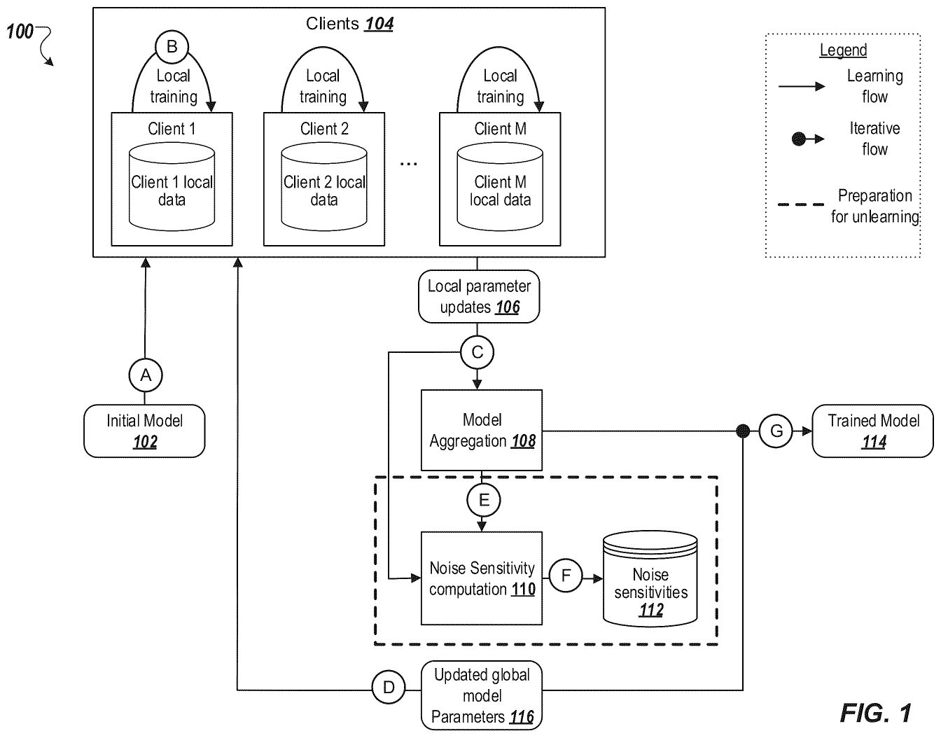

FIG. 1 is a block diagram of an example process 100 for smart collaborative learning of a machine learning model. The machine learning model is a parameterized model that can be trained on training data to perform a predictive task during inference on new, unseen data. Training the machine learning model includes iteratively adjusting machine learning model parameters θ from initial values to trained values using the training data. The training data includes multiple datasets that are owned by respective clients 1, 2, . . . , M.

During stage (A) of example process 100, a server initializes the machine learning model on an initial model 102. For example, the server can set values of the machine learning model parameters to initial values θ⁰, e.g., sampled from a normal distribution.

During stage (B), the server provides each of multiple available clients 104 with the initial machine learning model 102. In response to receiving the initial machine learning model 102, each client locally trains the initial machine learning model on their data to determine updated machine learning model parameters. For example, each client i of the available clients 104 can locally train the initial machine learning model on its own dataset [symbol] ᵢ by minimizing a loss function via stochastic gradient descent initialized on the initial machine learning model 102, e.g., the loss function given by Equation (1) below.

$$\\ \begin{matrix}{f}_{{𝒟}_{i}} ( θ ) := \frac{1}{\vert {𝒟}_{i} \vert} {\sum }_{j ∈ {𝒟}_{i}} f ( {x}_{j} , {y}_{j} , θ ) . & ( 1 )\end{matrix}$$

In Equation (1), [symbol] ᵢ represents the dataset owned by client i, | [symbol] ᵢ|=nᵢ represents the number of data samples included in the dataset [symbol] ᵢ, xⱼ is a feature vector of the j-th data sample, yⱼ is the prediction or label corresponding to xⱼ, and θ represents machine learning model parameters received from the server.

During stage (C), each client of the available clients 104 sends their locally updated machine learning model parameters 106 to the server. In some implementations, instead of directly sending the locally updated machine learning model parameters 106 to the server, one or more of the clients 104 can determine a difference between the locally updated machine learning model parameters and the global machine learning model parameters received from the server, e.g., θᵢⁿ⁺¹−θⁿ where θⁿ represents the received global machine learning model parameters (which at stage (C) corresponds to the first iteration n=0) and θᵢⁿ⁺¹ represents client i's locally updated machine learning model parameters (which at stage (C) corresponds to iteration n+1=1.)

Because the clients 104 performed local training of the machine learning model on their own dataset, the locally updated machine learning model parameters 106 (or differences) received by the server will differ. Therefore, to determine updated (global) machine learning model parameters the server aggregates 108 the received locally updated machine learning model parameters 106. For example, the server can compute the updated (global) machine learning model parameters as a weighted average of the locally updated machine learning model parameters as given by Equation (2) below.

$$\\ \begin{matrix}{θ}^{n + 1} = \frac{1}{\vert 𝒟 \vert} {\sum }_{i = 1}^{M} \vert {𝒟}_{i} \vert {θ}_{i}^{n + 1} . & ( 2 )\end{matrix}$$

In Equation (2), θⁿ⁺¹ represents the aggregated global machine learning parameters for iteration n+1 (which at stage (C) corresponds to the first iteration), | [symbol] | represents the size of the dataset [symbol] =U_{i∈1, 2, . . . M} [symbol] ᵢ, which is defined as the union of datasets on which the machine learning model was trained during stage (B), | [symbol] ᵢ| represents the size of the dataset owned by client i, and θᵢⁿ⁺¹ represents the machine learning model parameters locally updated by client i for iteration n+1.

During stage (D), the server provides each of the multiple available clients 104 with the updated global machine learning model parameters 116. The stages (B), (C), and (D) are then repeated for multiple subsequent iterations until the server obtains trained global machine learning model parameters. In some implementations the total number of iterations N performed by the server and clients 104 can be determined in advance. In other implementations the iterations can be performed until predetermined convergence criteria are met.

At each iteration, during stages (E) and (F), the server performs additional smart learning processing steps in preparation for smart unlearning. In some implementations stages (E) and (F) can be performed in parallel to stage (D).

During stage (E), the server computes a noise sensitivity 110 of each client that provided locally updated machine learning model parameters in previous stage (C). The noise sensitivities are metrics that track respective evolutions of an amount of client information included in the machine learning model during example process. In particular, the noise sensitivity of a particular client bounds a difference between the machine learning model trained on the multiple datasets owned by all of the available clients 104 and the machine learning model trained on the multiple datasets owned by the available clients 104 excluding the dataset owned by the particular client. That is, ∥θ₋ᵢⁿ−θⁿ∥₂≤Ψ(i, n), where Ψ(i, n) represents the noise sensitivity of client i at iteration n and ∥θ₋ᵢⁿ−θⁿ∥₂ represents the Euclidean norm of the difference between the machine learning model parameters θⁿ trained on the multiple datasets owned by all of the available clients and the machine learning model parameters θ₋ᵢⁿ trained on the multiple datasets owned by the available clients excluding the dataset owned by the particular client i.

The noise sensitivity Ψ can be defined as follows. At iteration n, the server contribution after one aggregation when training with dataset [symbol] ₓ on global machine learning model parameters θⁿ can be given by Equation (3) below.

$$\\ \begin{matrix}Δ ( {θ}^{n} , {𝒟}_{x} ) := \frac{1}{\vert {𝒟}_{x} \vert} {\sum }_{i ∈ {𝒟}_{x}} \vert {𝒟}_{i} \vert [ {θ}_{i}^{n + 1} - {θ}^{n} ] . & ( 3 )\end{matrix}$$

In Equation (3), | [symbol] ₓ| represents the size of the dataset [symbol] ₓ (which can include multiple client datasets [symbol] ᵢ), | [symbol] ᵢ| represents the size of the dataset owned by client i, and θᵢⁿ⁺¹−θⁿ represents the difference between client i's locally updated machine learning model parameters for the iteration n and the global machine learning model parameters for the iteration n.

This server contribution defines the noise sensitivity of client i after n iterations as given in Equation (4) below.

Ψ(i,n):=Σₛ₌₀ⁿ⁻¹∥Δ(θ^{s}, [symbol] )−Δ(θ^{s}, [symbol] ₋ᵢ)∥₂ (4)

In Equation (4), [symbol] represents the union of all datasets owned by the multiple available clients 104 for the n-th iteration, [symbol] ₋ᵢ represents [symbol] without the dataset owned by client i, and ∥.∥₂ represents a Euclidean norm. As shown, the noise sensitivity of a particular client can be computed by the server without any prior knowledge of the dataset owned by the particular client.

In implementations where the loss functions used by the clients 104 during stage (B) are L2 regularized and strongly convex with respective convexity parameters λ, μ, the noise sensitivity can instead be given by Equation (5) below.

Ψ(i,n)=Σₛ₌₀ⁿ⁻¹(1−η(λ+μ))^{(n-1-s)K}×∥Δ(θ^{s}, [symbol] )−Δ(θ^{s}, [symbol] ₋₁)∥₂ (5)

In Equation (4), η represents the stochastic gradient step size performed by the client during local training at stage (B), λ, μ represent loss function convexity parameters, K≥1 represents the amount of work performed by the client during the local training at stage (B).

The noise sensitivity defined in Equation (5) is tighter than the noise sensitivity defined in Equation (4) and also shows that previous information included in the machine learning model decreases over time, the training/learning is guaranteed to converge (therefore so does the noise sensitivity), and that the noise sensitivity is not necessarily inversely proportional to K. Indeed, due to data heterogeneity, with an increase in K every client local models gets closer to its local optimum and ∥Δ(θ^{s}, [symbol] )−Δ(θ^{s}, [symbol] ₋ᵢ)∥₂ increases with the amount of local work K. In addition, both Equation (4) and (5) show that clients have no data specificity when they have the same data distribution. In such cases, Δ(θ^{s}, [symbol] )=Δ(θ^{s}, [symbol] ₋ᵢ) which yields Ψ(i, n)=0.

During stage (F), the server stores the noise sensitivities for each client in noise sensitivity storage 112. The server also stores the global machine learning model parameters for the iteration in the noise sensitivity storage 112.

During stage (G), the global machine learning model parameters computed by the server in the final iteration of the stages (B)-(F) are used to define the trained machine learning model and the trained machine learning model is provided as output 114, e.g., for inference on new data.

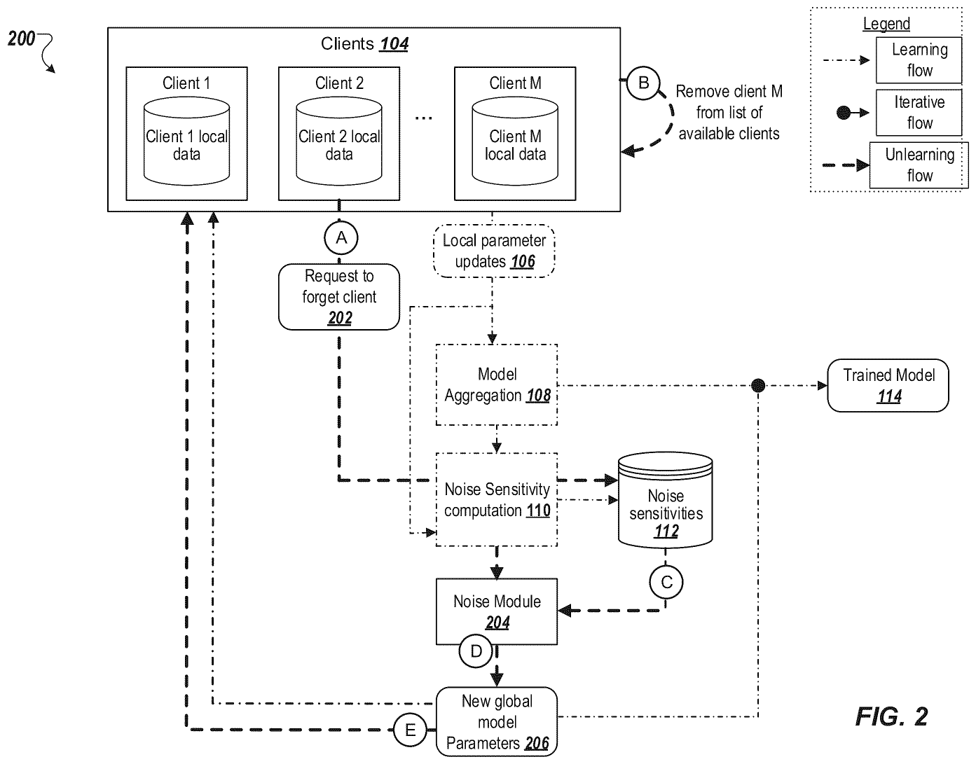

FIG. 2 is a block diagram of an example process 200 for smart collaborative unlearning of a machine learning model. During stage (A) of example process 200, the server receives a request 202 from one of the clients 104 (described above with reference to FIG. 1) to forget the client. The request can be received during learning, e.g., during example process 100 described above with reference to FIG. 1, or after the machine learning model has been output for production and used for inference on new data.

During stage (B), the server removes the requesting client from the multiple available clients 104. During stage (C), the server searches the noise sensitivities of the requesting client stored in the noise sensitivity storage 112 to identify a most recent training/learning iteration that produced a noise sensitivity for the requesting client that is below a predetermined threshold. In particular, the server identifies a most recent training iteration T∈{1, 2, . . . , N} that satisfies Equation (6) below.

$$\\ \begin{matrix}T := {max}_{n} Ψ ( i , n ) \leq {Ψ}^{*} & ( 6 )\end{matrix}$$

In Equation (6), n represents the iteration indices, i identifies the requesting client, and Ψ* represents the predetermined threshold. The predetermined threshold can be defined as follows.

To remove the specificities of a dataset owned by client i from a global machine learning model with learned machine learning model parameters θⁿ, Gaussian noise vᵢ(n) with 0 mean and standard deviation σᵢ(n) can be added to the machine learning model parameters θⁿ to obtain new machine learning model parameters \tilde{θ}=θⁿ+vᵢ(n). Using this technique, for

$$\\ {v}_{i} ( n ) \sim [ \frac{c Ψ ( i , n )}{ϵ} ] 𝒩 ( 0 , 1 ) with {c}^{2} > 2 ln ( \frac{1.25}{δ} ) ,$$

client i is (ϵ, δ)—forgotten in θⁿ+vᵢ(n). This shows that, for a fixed standard deviation common to every client in the multiple clients 104, i.e. σᵢ(n)=σ, the best global model to forget client i is client specific and also depends on the noise sensitivity for client i. The predetermined threshold for a privacy budget (ϵ, δ) is therefore defined as in Equation (7) below.

$$\\ \begin{matrix}{Ψ}^{*} := \frac{ϵ σ}{c} & ( 7 )\end{matrix}$$

In Equation (7), ϵ represents a first predefined target privacy parameter (that maintains a tradeoff between privacy and accuracy), σ represents the noise standard deviation, and c=2 ln(1.25/δ) where δ represents a predefined target privacy parameter (that represents the probability of privacy leak).

In some implementations, since Ψ(i, n) is strictly increasing in n, whenever there exists n₀ such that Ψ(i, n)>Ψ*, the server can stop computing the noise sensitivity for client i during stage (E) of example process 100.

During stage (D) of example process 200, the server retrieves global machine learning model parameters θ^{T} for the identified most recent iteration T and adds noise 204 to the global machine learning model parameters, e.g., noise sampled from a normal distribution with zero mean. That is, the server updates the current global machine learning model parameters according to Equation (8) below.

\tilde{θ}=θ^{T}+v (8)

where v˜ [symbol] (0, σ²) where σ represents the noise standard deviation. This update of the global machine learning model parameters satisfies (ϵ, δ)—forgotten privacy criteria.

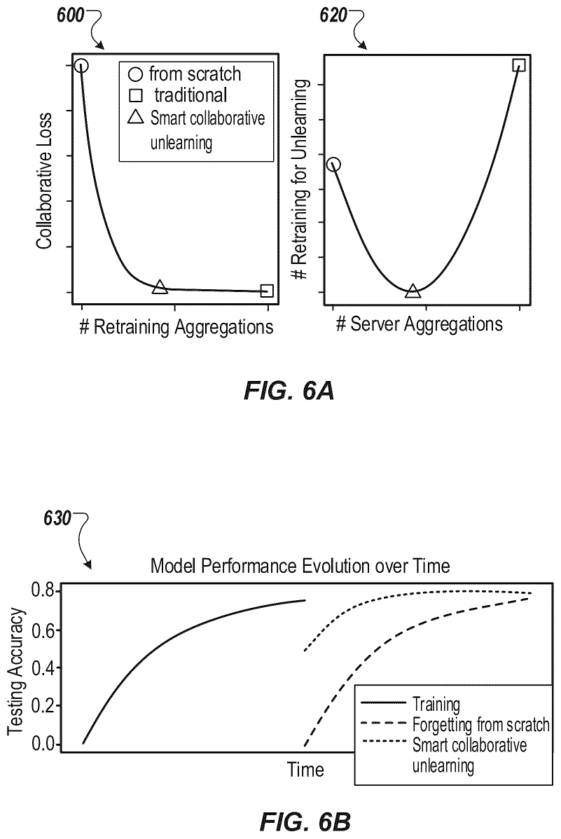

During stage (E), the server provides each of the remaining available clients 104 (e.g., all clients excluding the client that requested to be forgotten at stage (A)) with the updated global machine learning model parameters 206. The server and remaining available clients can then perform subsequent iterations of training of the machine learning model, where the machine learning model is initialized with the updated global machine learning model parameters 206 and the subsequent iterations train the machine learning model on multiple datasets excluding the dataset owned by the client that requested to be forgotten at stage (A). That is, the server and remaining available clients 104 can perform example process 100 described above with reference to FIG. 1, where at stage (A) of example process 100 the global machine learning model parameters are initialized using the updated global machine learning model parameters 206 instead of values sampled from a normal distribution. Because the updated global machine learning model parameters 206 retains information of the kept clients, the subsequent learning process is much shorter than the original learning process, as shown and described below with reference to FIGS. 6A and 6B.

In some implementations the server can receive a series of requests, where each request requests removal of one or more datasets owned by a respective set of clients from the machine learning model. For example, the server can receive a series of R requests {Wᵣ}ᵣ₌₁^{R} to forget a client, where Wᵣ represents a set of clients to forget at request r. In these implementations the server can label the global machine learning model parameters as θᵣⁿ where r represents the request to forget and n represents the amount of training iterations since retraining began. Therefore, θᵣ⁰ represents the initial retraining model forgetting every client in request Wᵣ and previous requests {Wₛ}ₛ₌₁^{r-1}

In these implementations the noise sensitivity can be given by Equation (9) below.

$$\\ \begin{matrix}Ψ ( i , r , n ) := {\sum }_{s = 0}^{n - 1} {‖ Δ ( {θ}_{r}^{s} , {D}_{r} ) - Δ ( {θ}_{r}^{s} , {D}_{r} \backslash {D}_{i} ) ‖}_{2} & ( 9 )\end{matrix}$$

In Equation (9), θᵣ^{s} represents the global machine learning model parameters where r represents the request to forget and s represents the amount of training iterations since retraining began, Dᵣ represents a dataset that includes the remaining client datasets after the set of clients Wᵣ in request r have been forgotten, i.e., Dᵣ:=D\∪ₛ₌₁^{r} Wₛ=Dᵣ₋₁\Wᵣ, and Dᵣ\Dᵢ represents the dataset Dᵣ without the dataset Dᵢ owned by client i. When i∉Dᵣ, Ψ(i, r, n)=0.

To forget a first client W₁={m₁}, client m₁ is forgotten on the global model with coordinates (ζ₁=0, T₁) such that the privacy criteria described above is satisfied for client m₁. To forget a new client W₂={m₂} after forgetting W₁={m₁} with m₁≠m₂, there are two cases to consider based on the noise sensitivity of client m₂ during forgetting index r=0 and r=1.

In the first case, Ψ(m₂, 0, T₁)≤Ψ*. In this case, the data specificities of client m₂ are (ϵ, δ)-forgotten with the ones of client m₁ when changing from r=0 to r=1 and the forgetting satisfying criterion described above are satisfied. In the second case, Ψ(m₂, 0, T₁)>Ψ*. In this case, the data specificities of client m₂ are not (ϵ, δ)-forgotten with the ones of client m₁ when changing from r=0 to r=1. Therefore, a global model in flow ζ₂=0 after T₂ aggregations is considered such that the noise variance is bounded by σ². By construction, T₂<T₁.

The above described reasoning conducted for R=2 and |Wᵣ|=1 can be extended to any amount of forgetting requests R and amount of clients |Wᵣ| in a forgetting request. First, the definitions of noise sensitivity described above can be extended to account for a set of clients to forget S as

$$\\ \begin{matrix}Ψ ( S , r , n ) = {max}_{i ∈ S} Ψ ( i , r , n ) . & ( 10 )\end{matrix}$$

When forgetting clients in Wᵣ, the current global model θᵣ₋₁^{N}^{_{r−1}} can be traced back to θ₀⁰ through its sequence of indices vᵣ={0, . . . , ζᵣ₋₁, r−1}. Therefore, ζᵣ can be defined as the first index in vᵣ for which the noise sensitivity of clients in Wᵣ is above our threshold, i.e. ζᵣ:=min{s∈vᵣ s. t. Ψ(Wᵣ, s, Tₛ)>Ψ*, r−1}, and the maximum amount of server aggregations before the forgetting noise variance exceeds the threshold

$$\\ \begin{matrix}{T}_{r} := {max}_{n} \{ Ψ ( {W}_{r} , {ζ}_{r} , n ) \leq {Ψ}^{*} \} . & ( 11 )\end{matrix}$$

That is, to summarize, in implementations where the server receives a series of requests to forget clients, during stages (E) and (F) of the learning process, the server can compute and store noise sensitivities Ψ(i, 0, n) for every i and n as given by Equation (9) above. Then, to unlearn a series of requests {Wᵣ}ᵣ₌₁^{R}=1 received at stage (A) of the unlearning process, the server can, for each r∈{1, . . . , R}, determine a dataset for the request r as Dᵣ=Dᵣ₋₁\Wᵣ, compute (ζᵣ, Tᵣ) as defined above with reference to Equation (11), define the new global model as θᵣ⁰=θ_{ζ}_{ᵣ}^{T}^{ᵣ}+N(0, σ²), and initialize retraining on θᵣ⁰, where during the retraining the server computes and stores the noise sensitivities Ψ(i, r, n).

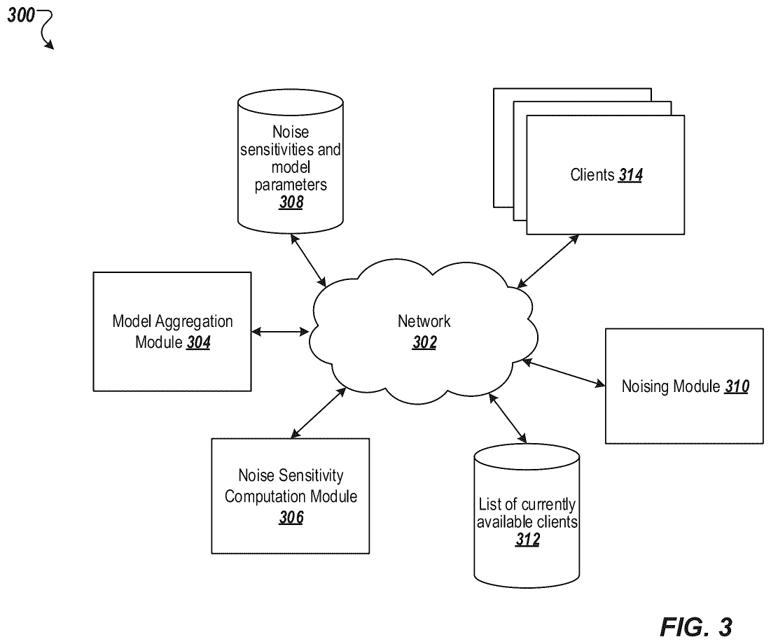

FIG. 3 is a block diagram of an example smart collaborative unlearning system 300. The example smart collaborative unlearning system 300 can be configured to implement the collaborative learning and unlearning processes described herein. The example smart collaborative unlearning system includes a network 302 (e.g., a local area network (LAN), wide area network (WLAN), the Internet, or a combination thereof). The network 302 can be accessed over a wired and/or a wireless communications link. The network 302 connects a model aggregation module 304, noise sensitivity computation module 306, noise sensitivity and global machine learning model parameters data store 308, noising module 310, list of currently available clients 312, and multiple clients 314.

The multiple clients 314 include clients that collaborate to train a machine learning model. Each client owns a respective dataset of data samples. Each client can be configured to train the machine learning model on its own dataset. For example, each client can be configured to receive values of machine learning model parameters from other system components, e.g., the aggregation module 304 or the noising module 310, and locally train the machine learning model on its own dataset by minimizing a loss function via stochastic gradient descent initialized on the received values of the machine learning model. Each client can then send the locally trained machine learning model back to the aggregation module 304. Because each client locally trains the machine learning model on its own dataset, the clients 314 do not exchange or share their datasets.

During smart collaborative learning, the model aggregation module 304 is configured to receive locally trained values of machine learning model parameters from each of the clients 314. In some implementations, to further increase data anonymity, the model aggregation module 304 can be configured to receive a difference between values of machine learning model parameters provided to a client and the client's locally trained values of machine learning model parameters. In these implementations the model aggregation module 304 can be configured to recover the locally trained values of machine learning model parameters from the received differences.

The model aggregation module 304 is configured to aggregate the received or recovered locally trained values of machine learning model parameters, e.g., according to Equation (2) above, to determine updated global machine learning model parameters. In some implementations, e.g., during collaborative learning of the machine learning model. the model aggregation module 304 can be configured to provide the updated global machine learning model parameters to the clients 314 for a subsequent iteration of training. In addition, the model aggregation module 304 is configured to provide the updated global machine learning model parameters to the noise sensitivity computation module 306.

During smart collaborative learning, the noise sensitivity computation module 306 is also configured to receive the locally trained values of machine learning model parameters from each of the clients 314, e.g., either directly or through another system component such as the model aggregation module 304. The noise sensitivity computation module 306 is also configured to receive the updated global machine learning model parameters from the model aggregation module 304. The noise sensitivity computation module 306 is configured to process the received inputs to compute a noise sensitivity of each of the clients 314. The type of noise sensitivity computed can vary, e.g., based on the type of loss function used by the clients 314 during local training and based on whether the system 300 is configured to accept sequences of requests to remove clients from the machine learning model during or after training. Example noise sensitivities are defined above with reference to FIGS. 1 and 2.

The noise sensitivity computation module 306 is configured to store computed noise sensitivities in the noise sensitivity and global machine learning model parameters data store 308. The noise sensitivity and global machine learning model parameters data store 308 is also configured to store global machine learning model parameters associated with the stored noise sensitivities.

During smart collaborative unlearning, the noising module 310 is configured to receive a request, e.g., from one or more of the clients 314, to remove one or more client datasets from the machine learning model. In response, the noising module 310 searches the noise sensitivity and global machine learning model parameters data store 308 to identify a most recently computed noise sensitivity for the client that satisfies the threshold given by Equation (7) above. The noising module 310 then retrieves global machine learning model parameters associated with the identified noise sensitivity and computes new global machine learning model parameters by adding noise to the retrieved global machine learning model parameters, e.g., according to Equation (8) above. The noising module 310 can then provide the new global machine learning model parameters to the clients 314 (excluding the client whose dataset was removed from the machine learning model) for subsequent training.

The list of currently available clients 312 is a data store that is configured to maintain a list of currently available clients, e.g., clients that participate in the collaborated learning. In response to receiving a request to remove one or more client datasets from the machine learning model, the list of currently available clients 312 can be updated to remove the one or more clients from the list.

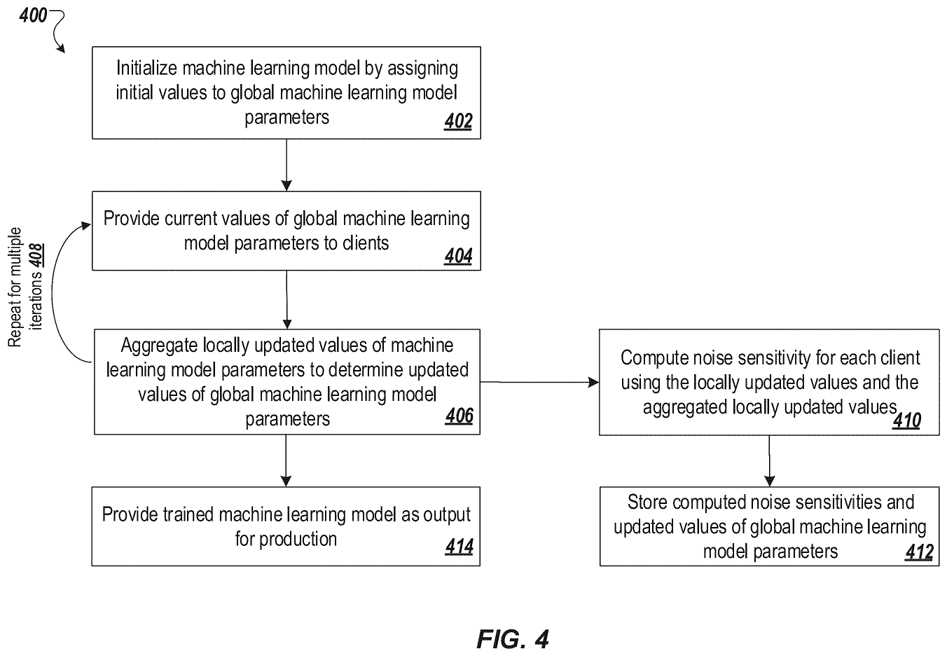

FIG. 4 is a flow chart of an example process 400 for smart collaborative learning of a machine learning model. For convenience, the process 400 will be described as being performed by a system of one or more computers located in one or more locations. For example, a computing system (e.g., the computing system 300 of FIG. 3), appropriately programmed, can perform example process 400.

The system initializes the machine learning model (step 402). For example, the system can set values of global machine learning model parameters to initial values e.g., sampled from a normal distribution.

The system then performs an iterative training procedure to adjust the values of the global machine learning model parameters to trained values. The training is performs on a federated training dataset (i.e., a collaborative training dataset) that includes multiple datasets owned by respective clients.

The iterative training procedure includes multiple iterations of learning. At each iteration of learning, the system provides the clients with current values of the global machine learning model parameters, e.g., for a first iteration the initial values or for subsequent iterations current values as determined during the previous iteration (step 404). Each client uses their respective dataset to update the current values of the global machine learning model parameters, e.g., by minimizing a loss function given by Equation (1) above using stochastic gradient descent, as described above with reference to FIG. 1. Since each client locally updates the current values of the global machine learning model parameters, the updated values are referred to herein as local values of the machine learning model parameters for the iteration.

The system receives the local values of the machine learning model parameters (or differences between the local values of the machine learning model parameters and the current values of the global machine learning model parameters) from each of the clients and aggregates the received local values to generate updated values of the global machine learning model parameters (step 406), e.g., according to Equation (2) above. The system provides the updated values of the global machine learning model parameters as an input for a subsequent iteration (step 408).

At each iteration, the system uses the received local values of the machine learning model parameters and the updated values of the global machine learning model parameters to compute a noise sensitivity of each client (step 410). The noise sensitivities track respective evolutions of an amount of client information included in the machine learning model during training. In particular, the noise sensitivity of a particular client bounds a difference between the machine learning model trained on the multiple datasets owned by the respective clients and the machine learning model trained on the multiple datasets excluding the dataset owned by the particular client. That is, ∥θ₋ᵢⁿ−θⁿ∥₂≤Ψ(i, n), where Ψ(i, n) represents the noise sensitivity of client i at iteration n and ∥θ₋ᵢⁿ−θⁿ∥₂ represents the Euclidean norm of the difference between the machine learning model parameters θⁿ trained on the multiple datasets owned by all of the clients and the machine learning model parameters θ₋ᵢⁿ trained on the multiple datasets owned by the clients excluding the dataset owned by the particular client i.

In some implementations the noise sensitivity can be defined as a sum, over all preceding training iterations, of a Euclidean norm of a difference between i) an aggregation of machine learning model parameters over the multiple datasets and ii) an aggregation of machine learning model parameters over the multiple datasets excluding the dataset owned by a particular client, as given by Equations (3) and (4) described above.

In other implementations the noise sensitivity of the client can include a weighted sum, over all preceding training iterations, of a Euclidean norm of the above described differences, where the weights are based on regularization and convexity parameters of loss functions used by the clients, as given by Equation (5) described above.

In other implementations the noise sensitivity can be defined as a maximum noise sensitivity from a set of noise sensitivities computed for a set of clients, where each noise sensitivity in the set of noise sensitivities includes a difference between i) an aggregation of machine learning model parameters over a federated dataset of remaining clients after forgetting a particular client in the set of clients and ii) an aggregation of machine learning model parameters over the federated dataset of remaining clients after forgetting clients in a same request excluding a dataset owned by the particular client in the set of clients. That is, the noise sensitivity can be given by Equations (9) and (10) described above.

The system stores the computed noise sensitives and the current values of the global machine learning model parameters (step 412).

After a predetermined number of iterations of steps (404), (406), (410), and (412) have been performed or after predetermined convergence criteria are satisfied, the system sets the values of the machine learning model parameters to trained values obtained from a last iteration, and outputs the trained machine learning model (step 414). The trained machine learning model can then be used in production for inference on new, unseen data samples.

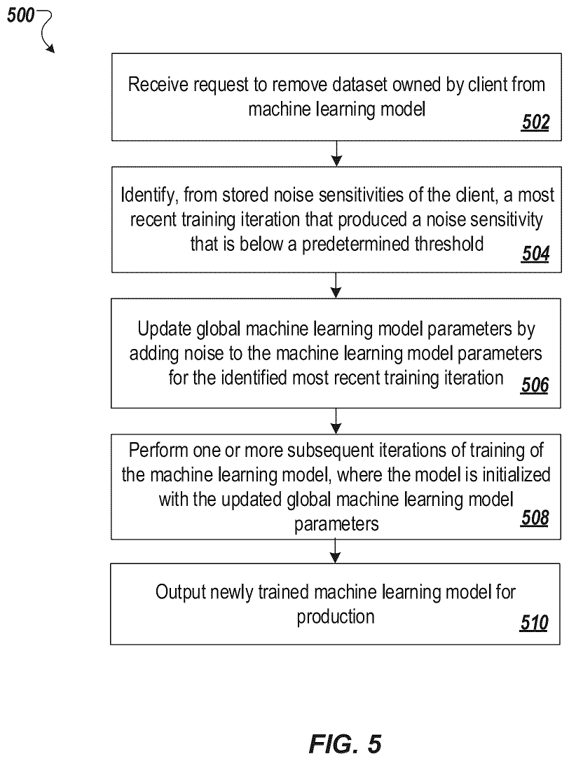

FIG. 5 is a flowchart of an example process 500 for smart collaborative unlearning of a machine learning model, e.g., the machine learning model trained using example process 400 described above. For convenience, the process 500 will be described as being performed by a system of one or more computers located in one or more locations. For example, a computing system (e.g., the computing system 300 of FIG. 3), appropriately programmed, can perform example process 500.

The system receives a request to remove a dataset owned by a client from a machine learning model (step 502). For example, in some implementations the dataset to be removed can be owned by an attacker, a client that induces bias in the machine learning model, or a client that does not respect general data protection regulations.

As described above with reference to steps 410 and 412 of example process 400, the machine learning model is associated with a set of noise sensitivities that are determined during training of the machine learning model on multiple datasets owned by respective clients including the client that is requesting to be forgotten. The noise sensitivities track respective evolutions of an amount of client information included in the machine learning model during training, where each noise sensitivity bounds a difference between the machine learning model trained on the multiple datasets and the machine learning model trained on multiple datasets excluding the dataset owned by a client. Example noise sensitivities are described above with reference to FIGS. 1 and 4.

In response to receiving the request, the system identifies, from the stored noise sensitivities of the client, a most recent training iteration that produced a noise sensitivity that is below a predetermined threshold (step 504). That is, the system identifies a training iteration T that satisfies Equation (6) described above. The predetermined threshold is based on a noise standard deviation (that is common to each client) and predefined target privacy parameters (ϵ, δ). In particular, the predetermined threshold can be given by ϵσ/c where ϵ represents a first predefined target privacy parameter, σ represents the noise standard deviation, and c=2 ln(1.25/δ) where δ represents a second predefined target privacy parameter, as described above with reference to Equation (7).

The system updates parameters of the machine learning model by adding noise to machine learning model parameters for the most recent training iteration (step 506). That is, the system can update the values of the machine learning model parameters using Equation (8) described above. In some implementations the noise can include noise sampled from a normal distribution with zero mean.

The system performs one or more subsequent iterations of training of the machine learning model (step 508), where in the first subsequent iteration, the machine learning model is initialized with the updated parameters and the subsequent iterations train the machine learning model on multiple datasets excluding the dataset owned by the client. Because the new initialization retains information of the remaining clients, the number of subsequent iterations of training that the system performs will less than the number of iterations performed during the previous training of the machine learning model.

In some implementations, the system can maintain a list of clients with datasets that have been used to train the machine learning model. In these implementations, in response to receiving the request, the system can remove the client from the list such that the client no longer participates in subsequent training procedures.

After the one or more subsequent iterations of training have been performed, the system can output the trained machine learning model, e.g., for inference on new, unseen data samples (step 510).

FIG. 6A shows two graphs 600, 620 that compare multiple unlearning approaches including retraining from scratch, traditional noising, and the presently described smart collaborative learning/unlearning approach. Graph 600 plots the evolution of the loss over the learning process and graph 620 plots the amount of retraining needed when unlearning the current global model.

Graphs 600 and 620 show that when retraining from scratch, a significant amount of retraining is needed to include information in the global model. When retraining via traditional noising, too much data specificities needs to be removed. Therefore, the noise amplitude is too high and data specificities from kept clients is also removed from the noised model. Using the presently described smart collaborative learning and unlearning approaches, the model kept for retraining maintains enough information to provide a fast retraining and not too much to degrade the global model with a noise of high amplitude.

FIG. 6B shows a graph 630 that compares the evolution of model performance during production. Graph 630 shows that when training with every client, the performance of the global model steadily increases over time. When retraining from scratch with the kept clients, the time needed for the performances to get back to level is much slower than when forgetting using the presently described smart collaborative unlearning approach.

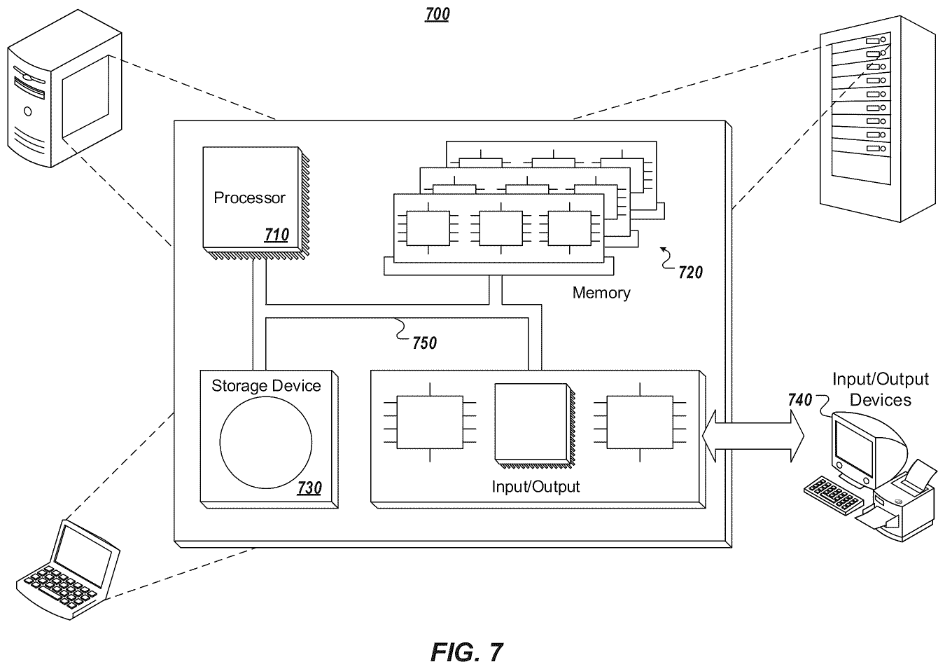

FIG. 7 is a schematic diagram of an exemplary computer system 700. The system 700 can be used for the operations described in association with the processes 400 and 500 described above according to some implementations. The system 700 is intended to represent various forms of digital computers, such as laptops, desktops, workstations, personal digital assistants, servers, blade servers, mainframes, mobile devices and other appropriate computers. The components shown here, their connections and relationships, and their functions, are exemplary only, and do not limit implementations of the inventions described and/or claimed in this document.

The system 700 includes a processor 710, a memory 720, a storage device 730, and an input/output device 740. Each of the components 710, 720, 730, and 720 are interconnected using a system bus 750. The processor 710 may be enabled for processing instructions for execution within the system 700. In one implementation, the processor 710 is a single-threaded processor. In another implementation, the processor 710 is a multi-threaded processor. The processor 710 may be enabled for processing instructions stored in the memory 720 or on the storage device 730 to display graphical information for a user interface on the input/output device 740.

The memory 720 stores information within the system 700. In one implementation, the memory 720 is a computer-readable medium. In one implementation, the memory 720 is a volatile memory unit. In another implementation, the memory 720 is a non-volatile memory unit.

The storage device 730 may be enabled for providing mass storage for the system 700. In one implementation, the storage device 730 is a computer-readable medium. In various different implementations, the storage device 730 may be a floppy disk device, a hard disk device, an optical disk device, or a tape device.

The input/output device 740 provides input/output operations for the system 700. In one implementation, the input/output device 740 includes a keyboard and/or pointing device. In another implementation, the input/output device 740 includes a display unit for displaying graphical user interfaces.

Implementations and all of the functional operations described in this specification may be implemented in digital electronic circuitry, or in computer software, firmware, or hardware, including the structures disclosed in this specification and their structural equivalents, or in combinations of one or more of them. Implementations may be implemented as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any form of programming language, including compiled or interpreted languages, and it may be deployed in any form, including as a stand alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both.

The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

To provide for interaction with a user, implementations may be implemented on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input.

Implementations may be implemented in a computing system that includes a back end component, e.g., as a data server, or that includes a middleware component, e.g., an application server, or that includes a front end component, e.g., a client computer having a graphical user interface or a Web browser through which a user may interact with an implementation, or any combination of one or more such back end, middleware, or front end components. The components of the system may be interconnected by any form or medium of digital data communication, e.g., a communication network. Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Thus, particular implementations have been described. Other implementations are within the scope of the following claims. For example, the actions recited in the claims may be performed in a different order and still achieve desirable results.

What is claimed is:

1. A computer implemented method comprising:
receiving a request to remove a dataset owned by a client from a machine learning model, the machine learning model being associated with a set of noise sensitivities determined during training of the machine learning model on multiple datasets owned by respective clients including the client; and
in response to receiving the request:
identifying, from stored noise sensitivities of the client, a most recent training iteration that produced a noise sensitivity that is below a predetermined threshold, wherein the predetermined threshold is based on a noise standard deviation and predefined target privacy parameters;
updating parameters of the machine learning model, comprising adding noise to machine learning model parameters for the most recent training iteration; and
performing one or more subsequent iterations of training of the machine learning model, wherein the machine learning model is initialized with the updated parameters and the subsequent iterations train the machine learning model on multiple datasets excluding the dataset owned by the client.

2. The method of claim 1, wherein each noise sensitivity bounds a difference between the machine learning model trained on the multiple datasets and the machine learning model trained on multiple datasets excluding the dataset owned by the client.

3. The method of claim 1, wherein the noise sensitivities track respective evolutions of an amount of client information included in the machine learning model during training.

4. The method of claim 1, wherein the noise sensitivity of the client is based on a difference between i) an aggregation of machine learning model parameters over the multiple datasets and ii) an aggregation of machine learning model parameters over the multiple datasets excluding the dataset owned by the client.

5. The method of claim 4, wherein the noise sensitivity of the client comprises a sum, over all preceding training iterations, of a Euclidean norm of the differences.

6. The method of claim 4, wherein the noise sensitivity of the client comprises a weighted sum, over all preceding training iterations, of a Euclidean norm of the differences, wherein the weights are based on regularization and convexity parameters of loss functions used by the clients.

7. The method of claim 1, wherein the noise standard deviation is common to each client.

8. The method of claim 1, wherein the predetermined threshold is given by ϵσ/c where ϵ represents a first predefined target privacy parameter, σ represents the noise standard deviation, and c=2 ln(1.25/δ) where δ represents a second predefined target privacy parameter.

9. The method of claim 1, wherein adding noise to machine learning model parameters comprises adding noise sampled from a normal distribution with zero mean.

10. The method of claim 1, wherein the method further comprises receiving a series of requests, each request requesting removal of one or more datasets owned by a respective set of clients from the machine learning model.

11. The method of claim 10, wherein the noise sensitivities determined during training of the machine learning model comprise a maximum noise sensitivity from a set of noise sensitivities computed for the set of clients.

12. The method of claim 11, wherein each noise sensitivity in the set of noise sensitivities comprises a difference between i) an aggregation of machine learning model parameters over a federated dataset of remaining clients after forgetting a client in the set of clients and ii) an aggregation of machine learning model parameters over the federated dataset of remaining clients after forgetting clients in a same request excluding a dataset owned by the client in the set of clients.

13. The method of claim 10, wherein the most recent training iteration that produced a noise sensitivity that is below a predetermined threshold is dependent on an index that represents a first training iteration for which noise sensitivities of the set of clients is above the predetermined threshold.

14. The method of claim 1, wherein the method further comprises, in response to receiving the request, removing the client from a list of currently available clients.

15. The method of claim 1, wherein the request to remove the dataset comprises a request to remove a dataset owned by one or more of: an attacker, a client that induces bias in the machine learning model, or a client that does not respect general data protection regulations.

16. The method of claim 1, wherein a number of subsequent iterations of training is less than a number of previous iterations performed during previous training of the machine learning model.

17. The method of claim 1, further comprising using the trained machine learning model for inference.

18. The method of claim 1, wherein training the machine learning model on the multiple datasets comprises:
initializing the machine learning model on initial machine learning model parameters;
for each of multiple iterations:
providing the clients with the initial machine learning model parameters or machine learning model parameters for a previous iteration, wherein each client uses a respective dataset to update the initial machine learning model parameters or machine learning model parameters for the previous iteration;
receiving, from each of the clients, machine learning model parameters for the iteration;
aggregating the received machine learning model parameters for the iteration; and
providing the aggregated machine learning model parameters for the iteration as input for a subsequent iteration.

19. A system comprising one or more computers and one or more storage devices storing instructions that are operable, when executed by the one or more computers, to cause the one or more computers to perform operations comprising:
receiving a request to remove a dataset owned by a client from a machine learning model, the machine learning model being associated with a set of noise sensitivities determined during training of the machine learning model on multiple datasets owned by respective clients including the client; and
in response to receiving the request:
identifying, from stored noise sensitivities of the client, a most recent training iteration that produced a noise sensitivity that is below a predetermined threshold, wherein the predetermined threshold is based on a noise standard deviation and predefined target privacy parameters;
updating parameters of the machine learning model, comprising adding noise to machine learning model parameters for the most recent training iteration; and
performing one or more subsequent iterations of training of the machine learning model, wherein the machine learning model is initialized with the updated parameters and the subsequent iterations train the machine learning model on multiple datasets excluding the dataset owned by the client.

20. A computer-readable storage medium comprising instructions stored thereon that are executable by a processing device and upon such execution cause the processing device to perform operations comprising:
receiving a request to remove a dataset owned by a client from a machine learning model, the machine learning model being associated with a set of noise sensitivities determined during training of the machine learning model on multiple datasets owned by respective clients including the client; and
in response to receiving the request:
identifying, from stored noise sensitivities of the client, a most recent training iteration that produced a noise sensitivity that is below a predetermined threshold, wherein the predetermined threshold is based on a noise standard deviation and predefined target privacy parameters;
updating parameters of the machine learning model, comprising adding noise to machine learning model parameters for the most recent training iteration; and
performing one or more subsequent iterations of training of the machine learning model, wherein the machine learning model is initialized with the updated parameters and the subsequent iterations train the machine learning model on multiple datasets excluding the dataset owned by the client.
